(19) United States
(12) Patent Application Publication
(10) Pub. No.: US 2011/0025049 A1
(43) Pub. Date: Feb. 3, 2011

(54) APPARATUS FOR CONNECTING PIPES

(76) Inventors: Suk Yoon Kim, Incheon (KR); Seo Ji Kim, Incheon (KR); Yu Sie Kim, Incheon (KR)

Correspondence Address: Hyun Jong Park;Park & Associates Intellectual Property Law LLC, 265 Bic Drive, Suite 106, Milford, CT, 06461, US

(21) Appl. No.: 12/905,909

(22) Filed: Oct. 15, 2010

Related U.S. Application Data
(63) Continuation of application No. PCT/KR2009/001871, filed on Apr. 11, 2009.

(30) Foreign Application Priority Data
Apr. 14, 2008 (KR) 10-2008-0033996

(51) Int. Cl. F16L 21/06

(52) U.S. Cl. 285/323

(57) ABSTRACT

The apparatus 100 of the present invention comprises a supporting body 110 for firmly supporting the pipe 10 from its inside, a guiding body 130 for guiding the movement of the supporting body 110 in longitudinal and radial directions of the pipe 10, an operating body 150 for operating the supporting body 110, the operating body 150 movably connected to the guiding body 110, a connecting member 170 for connecting the supporting body 110 and the operating body 150, and a contact preventing body 190 for preventing the direct contact between the operating body 150 and the connecting member 170 so as to guarantee the well operation of the operating body 150.

### REFERENCE TO RELATED APPLICATIONS

This application is a continuation of PCT international application Ser. No. PCT/KR2009/001871 filed on Apr. 11, 2009, which designates the United States and claims priority of KR Application Serial No. 10-2008-0033996, filed on Apr. 14, 2008, the entire contents of which are incorporated herein by reference.

### FIELD OF THE INVENTION

The present invention relates to an apparatus for internally connecting pipes, and more particularly, to an apparatus for internally connecting pipes enabling to easily and firmly connect two or more polygon or circular pipes from their insides.

### BACKGROUND OF THE INVENTION

Pipes are usually used to supply various fluids inclusive of gas or liquid in various industrial sites, and a plurality of pipes are used to be connected “I” type, “T” type or “L” type from each other according to working condition.

Apparatus for connecting pipes is widely supplied and used, and its representative example is disclosed in Korean Registered Patent No. 10-0593285 entitled “Apparatus for fixing pipes”.

As shown in FIGS. 11 and 12, the conventional the apparatus for fixing pipes is comprised of a body 10, a plurality of jaws 20 and a cylindrical plate spring for connecting jaws 30.

The body 10 is formed with a stepped portion 11 to which a pipe 1 is contacted therein, and also it is formed with a taper surface 12 to be narrower toward its entrance therein.

The jaw 20 is guided by the taper surface 12 of the body 10, and it is formed with a saw portion 21 to be contacted with the outer periphery surface of the body 10.

The plate spring 30 is detachably connected to the jaw 20, and it elastically pushes the jaw 20 toward the entrance.

In the conventional apparatus having the above described structure, the jaw 1 is slightly downwardly pushed by the frictional force generated between the outer periphery surface of the pipe 1 and the saw portion 21 when the pipe 1 is begun to be inserted into the body 10. At this time, the plate spring 30 is slightly compressed by the motion of the jaw 20. When the pipe 1 is completely inserted, the jaw 20 is moved toward the entrance by the elasticity of the compressed spring 30 and then it tightens the outer periphery surface of the pipe 1.

However, since the conventional apparatus having the above described structure is exposed from pipes, it is not proper to be applied in a working field such as building structures which should minimize the exterior exposure of the apparatus.

Further, the building structures is preferably required the polygon pipes such the quadrangle ones because it is given very great load, but the easy and firm connection of the pipes is very difficult.

### SUMMARY OF THE INVENTION

The present invention is created to solve a problem of the above-mentioned prior art, and accordingly one object of the present invention provides an apparatus for internally connecting pipes enabling to properly be applied to building structures by firmly connecting pipes from their insides to be not exteriorly exposed.

Another object of the present invention provides an apparatus for internally connecting pipes enabling to properly be applied to building structures to be given very great load by firmly connecting the polygon pipes such as the quadrangle ones from their insides.

In order to achieve the above-described objects, the present invention provides an apparatus for internally connecting pipes comprises a supporting body for firmly supporting the pipe from its inside, a guiding body for guiding the movement of the supporting body in longitudinal and radial directions of the pipe; and an operating body for operating the supporting body, the operating body movably connected to the guiding body.

The apparatus for connecting pipes of the present invention is characterized to further comprise a connecting member for connecting the supporting body and the operating body, and the connecting member is a compressed coil spring having an elastic force. And, the apparatus for connecting pipes of the present invention is characterized to further comprise a contact preventing body for preventing the direct contact between the operating body and the connecting member so as to guarantee the good operation of the operating body, the contact preventing body disposed between the operating body and the connecting member.

The present invention is characterized in that the supporting body may have an angled surface, and the angled surface is formed with a plurality of saw typed protrusions evenly in its longitudinal direction, and it is further characterized in that the supporting body is divided to be corresponded with the number of corners of the pipe. The present invention is characterized in that the supporting body has a curved surface, and the curved surface is formed with a plurality of saw typed protrusions evenly in its longitudinal direction, and it is further characterized in that the supporting body is divided in three or four.

The present invention is characterized in that the guiding body has a slanted portion having a slanted angle to be corresponded with that of the slanted surface formed in the supporting body, a mounting portion mounted with the operating body, and a stopping portion to stop the pipe to be provided between the slanted portion and the mounting portion, and it is further characterized in that the slanted portion becomes to be wider outwardly far from the mounting portion. The present invention is characterized in that the mounting portion has a quadrangle section, and the mounting portion is formed with threads on the corners thereof and positioned with the guiding body in other portion thereof, and it is further characterized in that the operating body is screwed to the mounting portion so as to be moved following to the mounting portion by its rotation.

The present invention is characterized in that the operating body is screwed to pass through a stopping portion provided at the end portion of the pipe, and the supporting body is moved by the rotation of the operating body.

The present invention is characterized in that the operating body has a moving member to move the supporting body, an installing member to firmly install the moving member onto the mounting portion, and a pivoting member to give straight movement of the moving member in longitudinal direction of the pipe by being pivoted to the installing member.

The present invention is characterized in that the stopping portion is outwardly extended from the mounting portion.

According to the apparatus for internally connecting pipes of the present invention, since pipes are firmly connected from their insides, its appearance is good and also it can be properly applied to building structures.

Further, since the polygon pipes such as the quadrangle ones are firmly connected from their insides, the apparatus can be properly applied to building structures to be given very great load.

Further, since the pipes are elastically supported by the apparatus, they can be endured from the outer force such as vibration.

### BRIEF DESCRIPTION OF THE DRAWINGS

The above and other objects and advantages of the present invention will become readily apparent by reference to the following detailed description when considered in conjunction with the accompanying drawing wherein:

FIG. 1 is a cross sectional view schematically illustrating the apparatus for internally connecting pipes according to a first preferred embodiment of the present invention;

FIG. 2 is a broken perspective view schematically illustrating the apparatus for connecting pipes in FIG. 1;

FIG. 3 is a cross sectional view schematically illustrating the apparatus for internally connecting pipes according to a second preferred embodiment of the present invention;

FIG. 4 is a cross sectional view schematically illustrating the apparatus for internally connecting pipes according to a third preferred embodiment of the present invention;

FIG. 5 is a cross sectional view schematically illustrating the apparatus for internally connecting pipes according to a fourth preferred embodiment of the present invention;

FIG. 6 is a perspective view schematically illustrating the supporting body in FIG. 5;

FIG. 7 is a view illustrating the feature in which two pipes are connected in “L” type by the apparatus in FIG. 1;

FIG. 8 is a view illustrating the feature in which the end of the pipe through which the fluid flows is blocked by the apparatus in FIG. 1;

FIG. 9 is a view illustrating the feature to gauge the inner pressure of the pipe by connecting a pressure gauge to the guiding body in FIG. 8;

FIG. 10 is a view illustrating the feature in which two pipes are connected in “I” type by the apparatus in FIG. 3;

FIG. 11 is a cross sectional view schematically illustrating the apparatus for fixing pipes in prior art; and

FIG. 12 is a view illustrating the feature in which two pipes are connected in “I” type by the apparatus in FIG. 11.

### DETAILED DESCRIPTION OF THE INVENTION

Hereinafter, the apparatus for internally connecting pipes according to preferred embodiments of the present invention will be described in detail with reference to the accompanying drawings.

### Embodiment 1

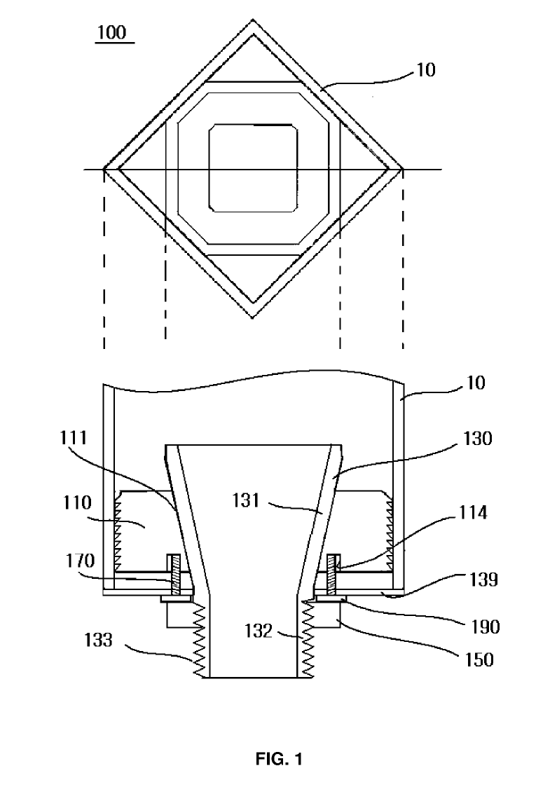

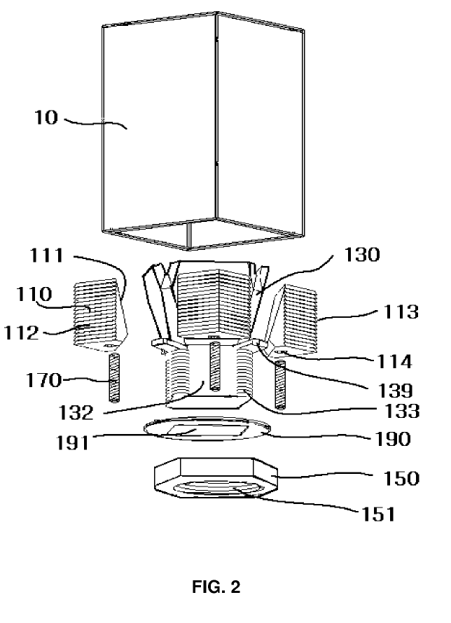

As shown in FIGS. 1 and 2, the apparatus 100 for internally connecting pipes according to a first preferred embodiment of the present invention comprises a supporting body 110, a guiding body 130, an operating body 150, a connecting member 170 and a contact preventing body 190.

The supporting body 110 is for firmly supporting the pipe 10 from its inside, and it is divided in four to be corresponded with the inner four corners of the quadrangle pipe 10. In this embodiment, the supporting body 110 is four, but it may be three or five to be corresponded with the number of the corners in case of a triangle or a pentagon pipes.

The supporting body 110 has a slanted surface 111 on its inside and an angled surface 112 on its outside, and the angled surface 112 is formed with a plurality of saw typed protrusions 113 evenly in its longitudinal direction. The plurality of protrusions 113 are formed to be slanted toward the entering direction of the pipe 10.

Further, the supporting body 110 is formed with inserting grooves 114 from its bottom surface.

The guiding body 130 is for guiding the movement of the supporting body 110 in longitudinal and radial directions of the pipe 10, and it is provided with a slanted portion 131, a mounting portion 132 and a stopping portion 139 in one body.

The slanted portion 131 becomes to be wider outwardly far from the mounting portion 131 so as to guide the supporting body 110 in longitudinal and radial directions of the pipe 10. To well guide the supporting body 110, the slanted portion 131 and the slanted surface 111 of the supporting body 110 has same slanted angle.

The mounting portion 132 has a quadrangle section, and it is formed with threads 133 on the four corners thereof and positioned with the guiding body 130 in other portion thereof.

The stopping portion 139 is outwardly extended from the connected portion of the slanted portion 131 and the mounting portion 132, and it supports the end of the pipe 10 so as that the pipe 10 is stopped between the slanted portion 131 and the mounting portion 132.

The operating body 150 is for operating the supporting body 110, the body 150 movably connected to the guiding body 130, and the body 150 has an inner periphery surface formed with threads 151 corresponding to the threads 133 formed on the mounting portion 131 thereon and an periphery surface shaped in hexagon or octagon. Therefore, the operating body 150 is screwed to the mounting portion 132 of the guiding body 130 and then it may be moved following to the mounting portion 132 by its rotation.

The connecting member 170 is for connecting the supporting body 110 and the operating body 150, and a compressed coil spring is applied as the connecting member 170 to give an elastic force in this embodiment. The connecting member 170 is inserted firmly or loosely in the inserting grooves 114 formed on the supporting body 110.

The contact preventing body 190 is for preventing the direct contact between the operating body 150 and the connecting member 170 so as to guarantee the good operation of the operating body 150, and a washer is properly applied as the contact preventing body 190 in this embodiment and it is disposed between the operating body 150 and the connecting member 170.

The contact preventing body 190 is formed with a quadrangle opening 191 to be loosely contacted with the four corners on which the threads 133 are not formed of the mounting portion 131.

According to the first embodiment described above, when the operating body 150 is rotated in clockwise direction and moved upwardly following to the mounting portion 131 of the guiding body 130, the contact preventing body 190 is moved upwardly together with the operating body 150. And, the connecting member 170 pushes upwardly the supporting body 110 by the movement of the contact preventing body 190. At this time, the supporting body 110 is moved at the same time in longitudinal and radial direction of the pipe 10, that is, it is moved obliquely to be closely contacted onto the inner wall of the pipe 10.

Meanwhile, when the operating body 150 is rotated in counter-clockwise direction and moved downwardly following to the mounting portion 131 of the guiding body 130, the connecting member 170 is also moved downwardly and then the supporting body 110 is downwardly moved by its self-weight. At this time, the supporting 110 is far from the inner wall of the pipe 10.

### Embodiment 2

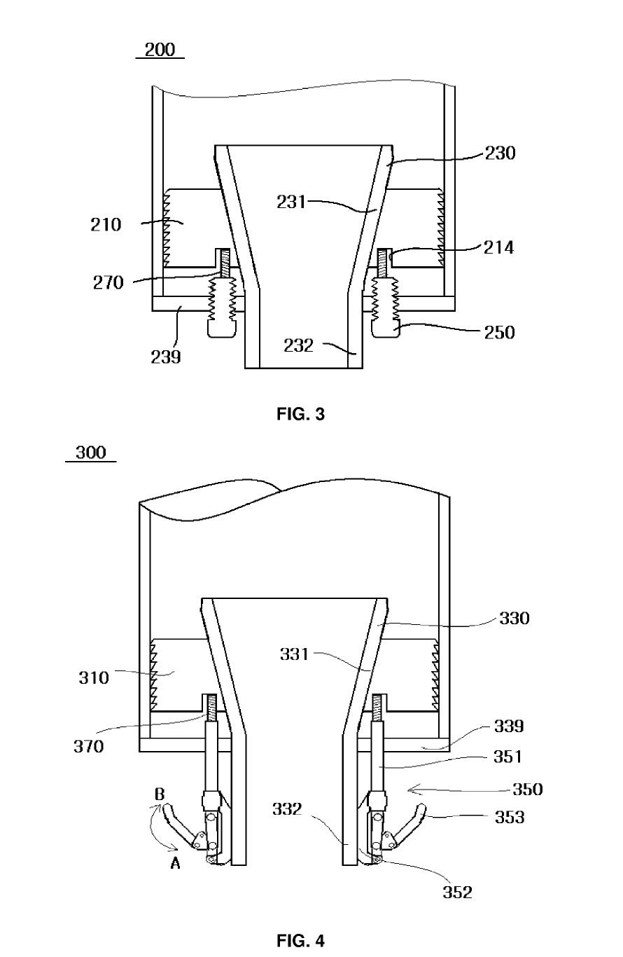

As shown in FIG. 3, the apparatus 200 for internally connecting pipes according to a second preferred embodiment of the present invention comprises a supporting body 210, a guiding body 230, an operating body 250 and a connecting member 270.

The supporting body 210 is substantially same as the supporting body 110 of the first embodiment, and therefore its specific explanation will be omitted.

The guiding body 230 is also substantially same as the guiding body 130 of the first embodiment except for that a mounting portion 232 is not formed with threads, and therefore its specific explanation will be omitted.

The operating body 250 shaped in a bolt, and it is screwed to pass through a stopping portion 239 provided at the end portion of the pipe 10, that is, at the connection portion of a slanted portion 231 and the mounting portion 232.

The connecting member 270 is disposed between the supporting body 210 and the operating body 250. In this embodiment, a compressed coil spring is applied as the connecting member 270 to give elastic fore. The connecting member 270 is firmly or loosely inserted in inserting grooves 214 formed on the supporting 210.

According to the second embodiment described above, when the operating body 250 is rotated in clockwise direction and moved upwardly, the connecting member 270 pushes upwardly the supporting body 210. At this time, the supporting body 210 is moved at the same time in longitudinal and radial direction of the pipe 10 by the slanted portion 231, that is, it is moved obliquely to be closely contacted onto the inner wall of the pipe 10.

Meanwhile, when the operating body 250 is rotated in counter-clockwise direction and moved downwardly, the connecting member 270 is also moved downwardly and then the supporting body 210 is downwardly moved by its self-weight. At this time, the supporting 210 is far from the inner wall of the pipe 10.

### Embodiment 3

As shown in FIG. 4, the apparatus 300 for internally connecting pipes according to a third preferred embodiment of the present invention comprises a supporting body 310, a guiding body 330, an operating body 350 and a connecting member 370.

The supporting body 310 is substantially same as the supporting body 110 of the first embodiment, and therefore its specific explanation will be omitted.

The guiding body 330 is also substantially same as the guiding body 130 of the first embodiment except for that a mounting portion 332 is not formed with threads, and therefore its specific explanation will be omitted.

The operating body 350 has a moving member 351 to move the supporting body 310, an installing member 352 to firmly install the moving member 351 onto the mounting portion 332, and a pivoting member 353 to give straight movement of the moving member 351 in longitudinal direction of the pipe 10 by being pivoted to the installing member 352. The pivoting member 353 is formed to be conveniently rotated in arrow A-B directions by a user.

According to the third embodiment described above, when the pivoting member 353 is rotated in arrow A direction, the moving member 351 is moved upwardly and then the connecting member 370 pushes the supporting member 310 upwardly. At this time, the supporting body 310 is moved at the same time in longitudinal and radial direction of the pipe 10 by the slanted portion 331 of the guiding body 330, that is, it is moved obliquely to be closely contacted onto the inner wall of the pipe 10.

Meanwhile, when the pivoting member 353 is rotated in arrow B direction, the moving member 351 is moved downwardly and then the supporting member 310 is moved downwardly by its self-weight. At this time, the supporting 310 is far from the inner wall of the pipe 10.

### Embodiment 4

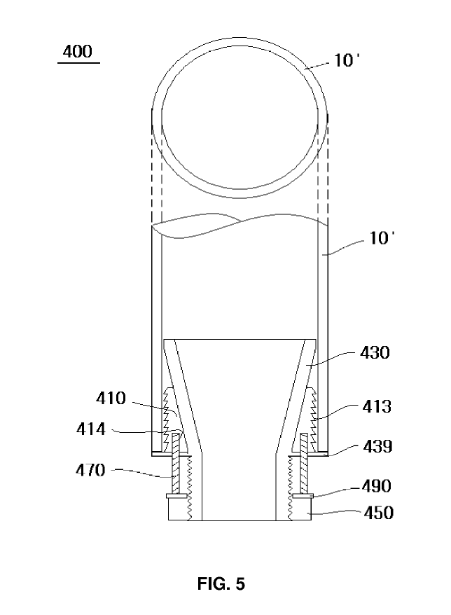

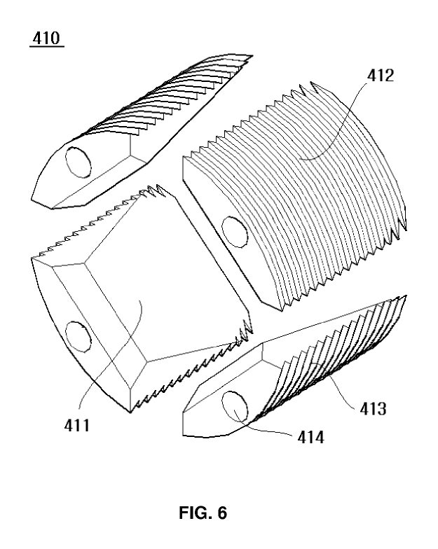

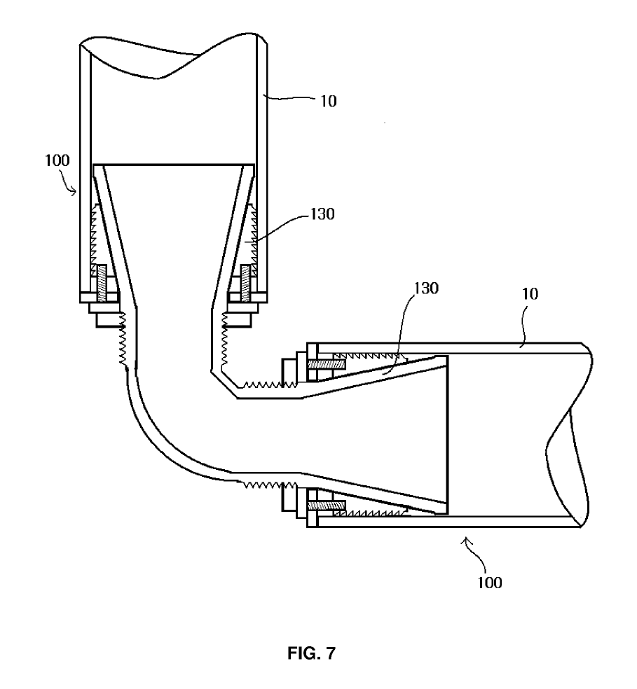

As shown in FIGS. 5 and 6, the apparatus 400 for internally connecting pipes according to a fourth preferred embodiment of the present invention comprises a supporting body 410, a guiding body 430, an operating body 450, a connecting member 470 and a contact preventing body 490. This embodiment is one example to be applied to connect a cylindrical pipe 10′, and other elements except for the supporting body 410 are same as those of the first embodiment, and therefore their specific explanation will be omitted.

The supporting body 410 is divided in four, and each divided supporting body 410 has an inside formed with a slanted surface 411 and an outside formed with a curved surface 412. The curved surface 412 is formed with a plurality of saw typed protrusions 413 evenly in its longitudinal direction. The plurality of protrusions 413 are formed to be slanted toward the entering direction of the pipe 10′.

Further, the supporting body 410 is formed with inserting grooves 414 from its bottom surface.

The operation of the fourth embodiment is substantially same as that of the first embodiment, and therefore its specific explanation will be omitted.

The representative example applied with the apparatus for internally connecting pipes according to any one of the first to fourth preferred embodiments of the present invention is illustrated in FIGS. 7 to 10.

FIG. 7 illustrates the feature in which two pipes are connected in “L” type by the apparatus in FIG. 1. In FIG. 7, the guiding body 130 is slightly changed such that two same guiding bodies 130 are connected by an “L” typed elbow.

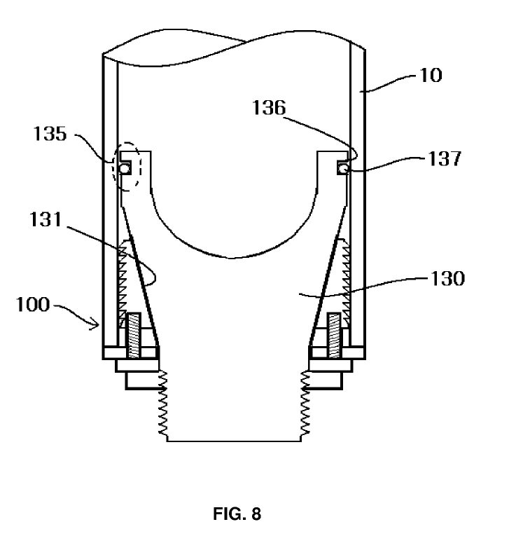

FIG. 8 illustrates the feature in which the end of the pipe through which the fluid flows is blocked by the apparatus in FIG. 1. Herein, the guiding body 130 is slightly changed such that it has a sealing portion 135 extended from the slanted portion 131. The sealing portion 135 is formed to be loosely inserted in the pipe 10, and it is provided with a sealing 137 on the annular groove 136 for sealing.

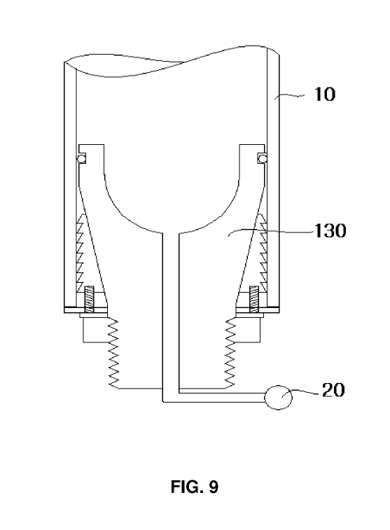

FIG. 9 illustrates the feature to gauge the inner pressure of the pipe 10 by connecting a pressure gauge 20 to the guiding body 130 in FIG. 8.

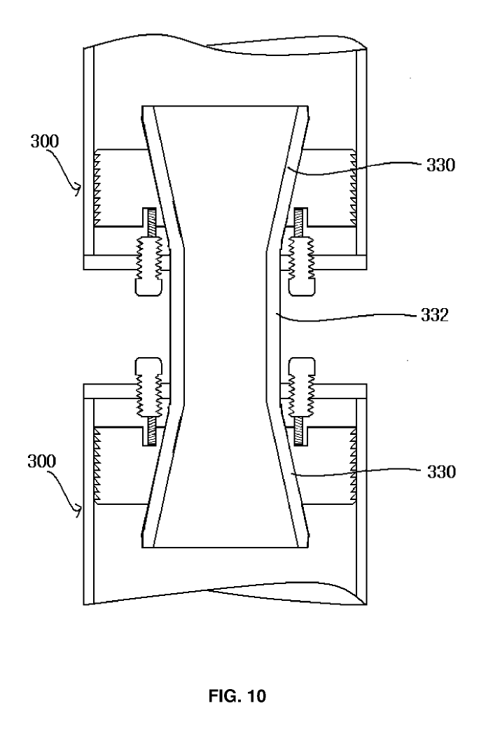

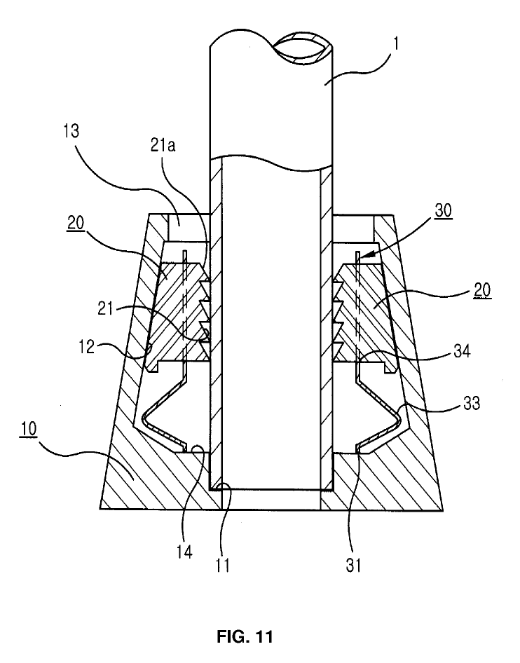

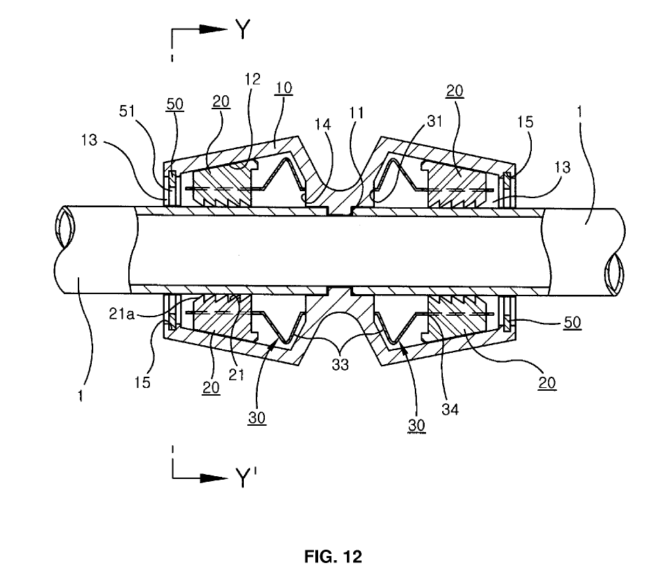

FIG. 10 illustrates the feature in which two pipes are connected in “I” type by the apparatus 300 in FIG. 3. In FIG. 10, the guiding body 330 is slightly changed such that the mounting portions 332 of two same guiding bodies 330 are connected in one body to be faced from each other.

The apparatus for internally connecting pipes of the present invention may be applied to connect a cylindrical pipe and a quadrangle pipe from each other, and a large pipe and small pipe from each other. Also, the apparatus for internally connecting pipes of the present invention may be applied to fluid pipe field as a stopper, and to various typed building structures.

Although the preferred embodiments of the present invention have been described, it is understood that the present invention should not be limited to this preferred embodiment but various changes and modifications can be made by one skilled in the art within the sprit and scope of the present invention aimed.

What is claimed is:

1. An apparatus for internally connecting pipes, the apparatus comprising:
a supporting body for firmly supporting the pipe from its inside;
a guiding body for guiding the movement of the supporting body in longitudinal and radial directions of the pipe; and
an operating body for operating the supporting body, the operating body movably connected to the guiding body.

2. The apparatus according to claim 1, further comprising a connecting member for connecting the supporting body and the operating body.

3. The apparatus according to claim 2, further comprising a contact preventing body for preventing the direct contact between the operating body and the connecting member so as to guarantee the good operation of the operating body, the contact preventing body disposed between the operating body and the connecting member.

4. The apparatus according to claim 2, wherein the supporting body has an angled surface, and the angled surface is formed with a plurality of saw typed protrusions evenly in its longitudinal direction.

5. The apparatus according to claim 2, wherein the supporting body has a curved surface, and the curved surface is formed with a plurality of saw typed protrusions evenly in its longitudinal direction.

6. The apparatus according to claim 2, wherein the connecting member is a compressed coil spring having an elastic force.

7. The apparatus according to claim 6, further comprising a contact preventing body for preventing the direct contact between the operating body and the connecting member so as to guarantee the good operation of the operating body, the contact preventing body disposed between the operating body and the connecting member.

8. The apparatus according to claim 1, wherein the supporting body has an angled surface, and the angled surface is formed with a plurality of saw typed protrusions evenly in its longitudinal direction.

9. The apparatus according to claim 8, wherein the supporting body is divided to be corresponded with the number of corners of the pipe.

10. The apparatus according to claim 1, wherein the supporting body has a curved surface, and the curved surface is formed with a plurality of saw typed protrusions evenly in its longitudinal direction.

11. The apparatus according to claim 10, wherein the supporting body is divided in three or four.

12. The apparatus according to claim 1, wherein the guiding body has a slanted portion having a slanted angle to be corresponded with that of the slanted surface formed in the supporting body, a mounting portion mounted with the operating body, and a stopping portion to stop the pipe to be provided between the slanted portion and the mounting portion.

13. The apparatus according to claim 12, wherein the slanted portion becomes to be wider outwardly far from the mounting portion.

14. The apparatus according to claim 13, wherein the mounting portion has a quadrangle section, and the mounting portion is formed with threads on the corners thereof and positioned with the guiding body in other portion thereof.

15. The apparatus according to claim 14, wherein the operating body is screwed to the mounting portion so as to be moved following to the mounting portion by its rotation.

16. The apparatus according to claim 13, wherein the operating body is screwed to pass through a stopping portion provided at the end portion of the pipe, and the supporting body is moved by the rotation of the operating body.

17. The apparatus according to claim 13, wherein the operating body has a moving member to move the supporting body, an installing member to firmly install the moving member onto the mounting portion, and a pivoting member to give straight movement of the moving member in longitudinal direction of the pipe by being pivoted to the installing member.

18. The apparatus according to claim 12, wherein the stopping portion is outwardly extended from the mounting portion.
